(19) United States
(12) Patent Application Publication
(10) Pub. No.: US 2024/0117174 A1
(43) Pub. Date: Apr. 11, 2024

(54) PVC RESIN COMPOSITION AND METHOD FOR MANUFACTURING PIPE HAVING HIGH HEAT RESISTANCE AND TRANSPARENCY

(71) Applicant: NAN YA PLASTICS CORPORATION, Taipei (TW)

(72) Inventors: TE-CHAO LIAO, TAIPEI (TW); HAN-CHING HSU, TAIPEI (TW); CHUN-LAI CHEN, TAIPEI (TW); WEN-YI WU, TAIPEI (TW)

(21) Appl. No.: 18/079,961

(22) Filed: Dec. 13, 2022

(30) Foreign Application Priority Data
Oct. 7, 2022 (TW) 111138114

(51) Int. Cl. C08L 27/06

(52) U.S. Cl. CPC C08L 27/06; C08L 2205/035

(57) ABSTRACT

A PVC resin composition and a method for manufacturing a pipe having high heat resistance and transparency are provided. The PVC resin composition includes 100 phr of a PVC resin, 0.5 phr to 5 phr of a modifier, and 1 phr to 10 phr of a heat resistance improving agent. A degree of polymerization of the PVC resin is from 800 to 1,350. The modifier is a polymer containing a first monomer and a second monomer. The first monomer is ethylene or a derivative of the ethylene, and the second monomer is a polyester.

### CROSS-REFERENCE TO RELATED PATENT APPLICATION

This application claims the benefit of priority to Taiwan Patent Application No. 111138114, filed on Oct. 7, 2022. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a resin composition, and more particularly to a polyvinyl chloride resin composition, and a method for manufacturing a pipe having high heat resistance and transparency from the polyvinyl chloride resin composition.

### BACKGROUND OF THE DISCLOSURE

Polyvinyl chloride (PVC) is a commonly used plastic having high production yield, wide application, and excellent comprehensive performance. With the continuous industrial development, the demand for high-performance PVC transparent materials has gradually increased. PVC has the advantages of requiring less investment on facilities, and having low price, and a formula of PVC can be adjusted according to different usages or performance requirements, such that PVC has a wide application prospect.

In processes commonly used in industries such as semiconductors, electronics, chemistry, water treatment, and pharmaceuticals, various types of fluids need to be transported into a processing device through pipelines, and the fluids may have hazardous characteristics such as corrosivity, toxicity, inflammability, and explosibility. In order to prevent the fluids from causing harm to personnel or devices and polluting environments in the transportation process, a transparent pipe made of PVC is generally sleeved outside a circulation pipeline of the fluids, thereby preventing the fluids from leaking to the surrounding environment. Furthermore, the transparent pipe has high visibility, so that personnel on site can directly and visually inspect whether or not any leakage of the fluids has occurred on the circulation pipeline.

Existing transparent pipes made of PVC all have plasticizers and high-proportion external lubricants added in the materials of the transparent pipe. However, when a plasticizer is added, a melt viscosity of a rubber material is too low, which is not beneficial for the processing of a pipe; moreover, the addition of a high-proportion external lubricant results in reduced transparency and increased haze of the transparent pipe.

### SUMMARY OF THE DISCLOSURE

In response to the above-referenced technical inadequacies, the present disclosure provides a PVC resin composition that can be used for manufacturing a pipe having high heat resistance and transparency without adding any plasticizer. Furthermore, the present disclosure provides a method for manufacturing a pipe having high heat resistance and transparency.

In one aspect, the present disclosure provides a PVC resin composition for manufacturing a pipe having high heat resistance and transparency. The PVC resin composition includes: (A) 100 phr of a PVC resin, in which a degree of polymerization of the PVC resin is from 800 to 1,350; (B) 0.5 phr to 5 phr of a modifier, in which the modifier is a polymer containing a first monomer and a second monomer, the first monomer is ethylene or a derivative of ethylene, and the second monomer is a polyester; and (C) 1 phr to 10 phr of a heat resistance improving agent.

In certain embodiments, the modifier is a copolymer of the first monomer and the second monomer, the first monomer is ethylene, and the second monomer is vinyl acetate.

In certain embodiments, the modifier is a copolymer of the first monomer and the second monomer, the first monomer is vinylidene chloride, and the second monomer is vinyl versatate.

In certain embodiments, the heat resistance improving agent is an α-methacrylonitrile copolymer.

In certain embodiments, the PVC resin composition further includes: (D) at least one functional additive selected from a group consisting of a toughening agent, a heat stabilizer, a lubricant, and an antioxidant.

In certain embodiments, the toughening agent includes at least one of an acrylic resin (ACR) elastomer and a methyl methacrylate-butadiene-styrene resin (MBS resin) elastomer, and an addition amount of the toughening agent is from 1 phr to 10 phr relative to 100 phr of the PVC resin.

In certain embodiments, the heat stabilizer includes at least one of a thiol ester organotin, an epoxy compound, a hydrotalcite compound, and a calcium zinc stabilizer, and an addition amount of the heat stabilizer is from 1 phr to 5 phr relative to 100 phr of the PVC resin.

In certain embodiments, the lubricant includes at least one of polyethylene wax and oxidized polyethlene wax, and an addition amount of the lubricant is from 0.1 phr to 0.5 phr relative to 100 phr of the PVC resin.

In certain embodiments, the antioxidant includes at least one of a hindered phenol antioxidant and a phosphite ester antioxidant, and an addition amount of the antioxidant is from 0.1 phr to 1 phr relative to 100 phr of the PVC resin.

In certain embodiments, the PVC resin includes at least one of a bulk-polymerized PVC resin and a suspension-polymerized PVC resin.

In another aspect, the present disclosure provides a method for manufacturing a pipe having high heat resistance and transparency. The method includes: sequentially performing hot mixing and cold mixing on the PVC resin composition composed of the aforementioned formula to obtain a mixed material; and melting the mixed material and performing extrusion molding on the mixed material.

In certain embodiments, the mixed material is heated to from 100° C. to 120° C. through hot mixing, and then is cooled to from 35° C. to 50° C. through cold mixing.

In certain embodiments, the melting temperature of the mixed material is from 170° C. to 200° C.

Therefore, the PVC resin composition of the present disclosure is composed of the abovementioned formula, that is, the PVC resin composition is a combination of a component (A), a component (B) and a component (C) in specific weight proportions, so that the PVC resin composition can achieve the beneficial effects of rapid plasticization at low temperature, reduced addition amounts of an external lubricant and an anti-impact agent, improved heat resistance and transparency (up to 85% or more) of products, and improved processing formability. Therefore, the PVC resin composition can satisfy the performance or process requirements of a transparent pipe (such as a protective pipe and a double-casing pipe), and can be widely applied to industries such as semiconductors, electronics, chemistry, water treatment, and pharmaceuticals. Moreover, the PVC resin composition composed of the abovementioned formula can be used for manufacturing a transparent pipe without adding any plasticizer.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a flowchart of steps for manufacturing a pipe having high heat resistance and transparency from a PVC resin composition according to one embodiment of the present disclosure; and

FIG. 2 is a schematic diagram of a use state of a pipe having high heat resistance and transparency manufactured from a PVC resin composition according to one embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

### PVC Resin Composition

Embodiments of the present disclosure provide a PVC resin composition that mainly includes the following components in phr: (A) 100 parts of a PVC resin with a degree of polymerization (DP) being from 800 to 1,350; (B) 0.5 parts to 5 parts of a modifier that is a polymer containing a first monomer and a second monomer, the first monomer being ethylene or a derivative of the ethylene, and the second monomer being a polyester; and (C) 1 part to 10 parts of a heat resistance improving agent.

It is worth mentioning that with the above formula, the PVC resin composition can achieve the beneficial effects of rapid plasticization at low temperature, reduced addition amounts of an external lubricant and an anti-impact agent, improved heat resistance and transparency (up to 85% or more) of products, and improved processing formability, thereby satisfying the performance or process requirements of a transparent pipe (such as a protective pipe and a double-casing pipe), and the PVC resin composition can be widely applied to industries such as semiconductors, electronics, chemistry, water treatment, and pharmaceuticals. Also, the PVC resin composition composed of the abovementioned formula can be used for manufacturing a transparent pipe without adding any plasticizer.

### Component (A) PVC Resin

In the present disclosure, the PVC resin, as a body resin, can be at least one of a bulk-polymerized PVC resin and a suspension-polymerized PVC resin, in which the bulk-polymerized PVC resin has higher plasticizing rate, and has higher transparency after being cured. When the degree of polymerization of the PVC resin is between 800 and 1,350, the characteristics of easy plasticization and blending and good processing flowability can be achieved. Preferably, the degree of polymerization of the PVC resin is between 800 and 1000.

### Component (B) Modifier

In the present disclosure, the modifier and the PVC resin may form a blending system so as to improve the physical and mechanical properties and the processing plasticizing property of the PVC resin material. Preferably, the modifier is a copolymer of a first monomer (ethylene or a derivative thereof) and a second monomer (a polyester). The first monomer may improve the compatibility between the modifier and PVC, optimize the properties of products, and promote the products to have high transparency. The second monomer has low glass transition temperature, so that the second monomer may promote the products to have high plasticity and good toughness; furthermore, the second monomer has poor adhesion to a metal surface (i.e., being easily peeled off from a metal surface), so that the addition amount of an external lubricant can be reduced.

However, in the present disclosure, the arrangement of the first monomer and the second monomer in the molecular structure of the modifier is not limited. In certain embodiments, the first monomer and the second monomer may be arranged irregularly. In certain embodiments, the first monomer and the second monomer may also be arranged orderly, for example, alternately arranged or continuously distributed in the form of blocks.

Further, the modifier is crucial to the final performance of a cured product of the PVC resin composition. The modifier can not only improve the plasticization rate, but also produce an anti-impact synergistic effect (i.e., an effect of synergistic anti-impact modification) when used in combination with a PVC toughening agent (e.g., an elastomer toughening agent). Accordingly, the addition amount of the anti-impact agent can be reduced, and the modifier can be used to replace a traditional gelling-promoting processing aid mainly including an acrylic ester compound. Furthermore, the second monomer of the modifier may provide a good lubricating effect, so the formula only requires a low-proportion external lubricant; accordingly, the haze of the product can be reduced, and the transparency of the product can be improved.

In practical applications, the modifier may be an ethylene-vinyl acetate copolymer, that is, the first monomer of the modifier is ethylene, and the second monomer is vinyl acetate; or the modifier may be a vinylidene chloride-vinyl versatate copolymer, that is, the first monomer of the modifier is vinylidene chloride, and the second monomer is vinyl versatate. However, the present disclosure is not limited to the above examples. The addition amount of the modifier in the PVC resin composition may be 0.5 phr, 1 phr, 1.5 phr, 2 phr, 2.5 phr, 3 phr, 3.5 phr, 4 phr, 4.5 phr, or 5 phr.

### Component (C) Heat Resistance Improving Agent

In the present disclosure, the heat resistance improving agent has a higher heat deflection temperature (HDT), and may form a blending system with the PVC resin, so that the heat resistance of products is significantly improved.

In practical applications, the heat resistance improving agent may be an α-methacrylonitrile copolymer, but is not limited thereto. The α-methacrylonitrile copolymer has a higher heat deflection temperature and good compatibility with PVC, and is beneficial to improving the heat resistance, toughness and transparency of products. However, the present disclosure is not limited to the above example. In practical applications, the addition amount of the heat resistance improving agent in the PVC resin composition may be 1 phr, 1.5 phr, 2 phr, 2.5 phr, 3 phr, 3.5 phr, 4 phr, 4.5 phr, 5 phr, 5.5 phr, 6 phr, 6.5 phr, 7 phr, 7.5 phr, 8 phr, 8.5 phr, 9 phr, 9.5 phr, or 10 phr.

### Component (D) Functional Additive

According to actual requirements, the PVC resin composition provided by the present disclosure may further include at least one functional additive including one or more components of the following group: (D-1) a toughening agent, (D-2) a heat stabilizer, (D-3) a lubricant, and (D-4) an antioxidant, that can be used alone or in combination.

In the present disclosure, the toughening agent may be distributed uniformly in a form of particles to absorb impact energy exerted by an external force, thereby achieving the toughening effect. In the toughening agent, when a resin matrix is impacted by an external force, micro-cracks will be formed between the toughening agent particles and the resin matrix, and plastic deformation of the resin matrix between the toughening agent particles will occur. However, the above is merely one of the feasible implementations and the present disclosure is not limited thereto.

The toughening agent may include at least one of an acrylic resin (ACR) elastomer and a methyl methacrylate-butadiene-styrene resin (MBS resin) elastomer, and the addition amount of the toughening agent in the composition may be from 1 phr to 10 phr. However, the present disclosure is not limited to the above examples. In certain embodiments, the addition amount of the toughening agent in the PVC resin composition may be 1 phr, 1.5 phr, 2 phr, 2.5 phr, 3 phr, 3.5 phr, 4 phr, 4.5 phr, 5 phr, 5.5 phr, 6 phr, 6.5 phr, 7 phr, 7.5 phr, 8 phr, 8.5 phr, 9 phr, 9.5 phr, or 10 phr.

In the present disclosure, the heat stabilizer may prevent or inhibit thermal decomposition of a PVC resin during processing. The heat stabilizer may include at least one of a thiol ester organotin (such as methyl tin mercaptide), an epoxy compound (such as epoxidized soybean oil), a hydrotalcite compound, and a calcium zinc stabilizer, and the addition amount of the heat stabilizer may be from 1 phr to 5 phr. However, the present disclosure is not limited to the above examples. In certain embodiments, the addition amount of the heat stabilizer in the PVC resin composition may be 1 phr, 1.5 phr, 2 phr, 2.5 phr, 3 phr, 3.5 phr, 4 phr, 4.5 phr, or 5 phr.

In the present disclosure, the lubricant reduces the friction between a melt and a surface of a processing machine, so that the lubricant may prevent a resin material from being deposited on the surface of a machine (such as an extruder, a processing machine roller, and a forming mold). However, the above is merely one of the practical implementations and is not intended to limit the present disclosure. In certain embodiments, the lubricant can reduce the friction between polymer molecules, thereby improving the flowability of the resin material.

The lubricant may include at least one of polyethylene wax and oxidized polyethlene wax (OPE wax), and the addition amount of the lubricant in the composition may be from 0.1 phr to 0.5 phr. However, the present disclosure is not limited to the above examples. In certain embodiments, the addition amount of the lubricant in the composition may be 0.1 phr, 0.2 phr, 0.3 phr, 0.4 phr, or 0.5 phr.

In the present disclosure, the antioxidant not only can prevent or inhibit oxidative decomposition of the PVC resin during processing, but also can prevent or inhibit oxidative decomposition of the modifier (a polymer of ethylene or a derivative of ethylene and a polyester) and the heat resistance improving agent (such as an α-methacrylonitrile copolymer).

The antioxidant may include at least one of a hindered phenol antioxidant and a phosphite ester antioxidant, and the addition amount of the antioxidant in the composition is from 0.1 phr to 1 phr. However, the present disclosure is not limited to the above examples. In certain embodiments, the addition amount of the antioxidant in the composition may be 0.1 phr, 0.2 phr, 0.3 phr, 0.4 phr, 0.5 phr, 0.6 phr, 0.7 phr, 0.8 phr, 0.9 phr, or 1 phr.

Within the scope of the effect of the present disclosure, if there is a requirement on color and luster, the PVC resin composition provided by the present disclosure may further include a pigment, for example, an organic pigment and an inorganic pigment that are used individually or in combination.

### Method for Manufacturing a Pipe Having High Heat Resistance and Transparency

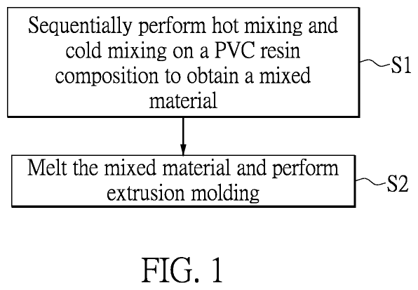

Referring to FIG. 1, according to the present disclosure, the PVC composition composed of the above formula may be used in a method for manufacturing a pipe with high heat resistance and transparency, and the method includes the following steps: step S1: sequentially performing hot mixing and cold mixing on the PVC resin composition composed of the above formula to obtain a mixed material; step S2: melting the mixed material and performing extrusion molding.

In step S1, raw material components of the PVC composition are added into a hot mixing machine according to the proportions and are subjected to hot mixing under the condition of high-speed stirring, so that the mixed material is heated to from 100° C. to 120° C., and then the mixed material is transferred to a cold mixing machine for cold mixing, so that the mixed material is cooled to from 35° C. to 50° C. In step S2, the mixed material is melted and extruded by an extruder at from 170° C. to 200° C., and the melt is formed and cooled to obtain the pipe with high heat resistance and transparency. However, the above is one feasible implementation, and is not intended to limit the pre sent disclosure.

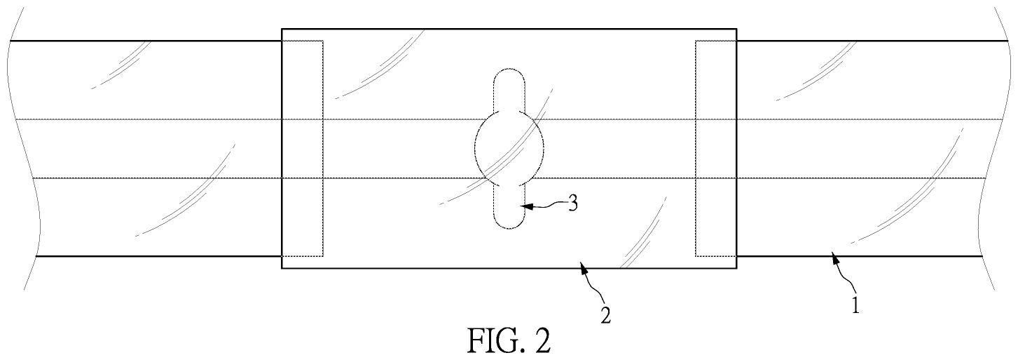

Referring to FIG. 2, a transparent pipe 1 manufactured by the method may be a protective pipe or a double-casing pipe, and may be applied to a conveying piping system of a fluid (such as a chemical liquid, a strong acid, or a strong alkali), thereby achieving monitoring and protection functions. For example, on-site personnel may monitor in real time the status of an inner circulating pipeline 2 and a valve body 3 through the transparent pipe 1, and in the event of an occurrence of an abnormality such as liquid leakage, the occurrence can be quickly eliminated. Furthermore, since the transparent pipe 1 can withstand high temperature, acid, and alkali, the danger and loss on site can be minimized.

It should be noted that, although the characteristics of the PVC resin composition of the present disclosure are described herein by exemplifying the transparent pipe, the PVC resin composition of the present disclosure can also be used in other applications, for example, in building materials and components.

Examples and comparative examples are given below to illustrate the effect of the present disclosure, but the scope of the present disclosure is not limited to the following implementations.

### Example 1

A PVC composition in Example 1 includes the following components in phr: 100 phr of a PVC resin, 2 phr of an ethylene-vinyl acetate copolymer, 10 phr of an α-methacrylonitrile copolymer, 1 phr of an MBS toughening agent, 2.5 phr of methyl tin mercaptide, 0.5 phr of epoxidized soybean oil, 0.1 phr of OPE wax, and 0.5 phr of antioxidant I-1010. The components are prepared according to the parts by weight and are put into a high-speed hot mixing machine for dispersing and stirring, in which the stirring temperature is set to be 110° C.; and then the mixed material is discharged into a cold mixing machine for stirring and cooling, and the material is discharged into a hopper after the temperature is lowered to be 40° C., and is extruded, formed and cooled through a double-screw extruder so as to obtain a PVC extruded pipe, in which the temperatures of barrels of the double-screw extruder are respectively set to be 185° C. and 170° C., and the molding temperatures are respectively set to be 175° C. and 190° C.

The PVC composition in Example 1 is used for manufacturing a sample pipe, the manufacturing method is as described above, and the physical properties of the sample pipe are measured. The results are as shown in Table 1.

### Example 2

A PVC composition in Example 2 includes the following components in phr: 100 phr of a PVC resin, 2 phr of an ethylene-vinyl acetate copolymer, 10 phr of an α-methacrylonitrile copolymer, 1 phr of an MBS toughening agent, 2.5 phr of methyl tin mercaptide, 0.5 phr of epoxidized soybean oil, 0.5 phr of OPE wax, and 0.5 phr of antioxidant I-1010. The components are prepared according to the parts by weight and are put into a high-speed hot mixing machine for dispersing and stirring, in which the stirring temperature is set to be 110° C.; and then the mixed material is discharged into a cold mixing machine for stirring and cooling, and the material is discharged into a hopper after the temperature is lowered to be 40° C., and is extruded, formed and cooled through a double-screw extruder so as to obtain a PVC extruded pipe, where the temperatures of barrels of the double-screw extruder are respectively set to be 185° C. and 170° C., and the molding temperatures are respectively set to be 175° C. and 190° C.

The PVC composition in Example 2 is used for manufacturing a sample pipe, the manufacturing method is as described above, and the physical properties of the sample pipe are measured. The results are as shown in Table 1.

### Example 3

A PVC composition in Example 3 includes the following components in phr: 100 phr of a PVC resin, 2 phr of a vinylidene chloride-vinyl versatate copolymer, 10 phr of an α-methacrylonitrile copolymer, 1 phr of an MBS toughening agent, 2.5 phr of methyl tin mercaptide, 0.5 phr of epoxidized soybean oil, 0.1 phr of OPE wax, and 0.5 phr of antioxidant I-1010. The components are prepared according to the parts by weight and are put into a high-speed hot mixing machine for dispersing and stirring, in which the stirring temperature is set to be 110° C.; and then the mixed material is discharged into a cold mixing machine for stirring and cooling, and the material is discharged into a hopper after the temperature is lowered to be 40° C., and is extruded, formed and cooled through a double-screw extruder so as to obtain a PVC extruded pipe, in which the temperatures of barrels of the double-screw extruder are respectively set to be 185° C. and 170° C., and the molding temperatures are respectively set to be 175° C. and 190° C.

The PVC composition in Example 3 is used for manufacturing a sample pipe, the manufacturing method is as described above, and the physical properties of the sample pipe are measured. The results are as shown in Table 1.

### Example 4

A PVC composition in Example 4 includes the following components in phr: 100 phr of a PVC resin, 2 phr of a vinylidene chloride-vinyl versatate copolymer, 10 phr of an α-methacrylonitrile copolymer, 1 phr of an MBS toughening agent, 2.5 phr of methyl tin mercaptide, 0.5 phr of epoxidized soybean oil, 0.5 phr of OPE wax, and 0.5 phr of antioxidant I-1010. The components are prepared according to the parts by weight and are put into a high-speed hot mixing machine for dispersing and stirring, in which the stirring temperature is set to be 110° C.; and then the mixed material is discharged into a cold mixing machine for stirring and cooling, and the material is discharged into a hopper after the temperature is lowered to be 40° C., and is extruded, formed and cooled through a double-screw extruder so as to obtain a PVC extruded pipe, in which the temperatures of barrels of the double-screw extruder are respectively set to be 185° C. and 170° C., and the molding temperatures are respectively set to be 175° C. and 190° C.

The PVC composition in Example 4 is used for manufacturing a sample pipe, the manufacturing method is as described above, and the physical properties of the sample pipe are measured. The results are as shown in Table 1.

### Comparative Example 1

A PVC composition in Comparative Example 1 includes the following components in phr: 100 phr of a PVC resin, 3 phr of a DOTP plasticizer (dioctyl terephthalate), 1 phr of an MBS toughening agent, 2.5 phr of methyl tin mercaptide, 0.5 phr of epoxidized soybean oil, 0.1 phr of OPE wax, and 0.5 phr of antioxidant I-1010. The components are prepared according to the parts by weight and are put into a high-speed hot mixing machine for dispersing and stirring, in which the stirring temperature is set to be 110° C.; and then the mixed material is discharged into a cold mixing machine for stirring and cooling, and the material is discharged into a hopper after the temperature is lowered to be 40° C., and is extruded, formed and cooled through a double-screw extruder so as to obtain a PVC extruded pipe, in which the temperatures of barrels of the double-screw extruder are respectively set be to 185° C. and 170° C., and the molding temperatures are respectively set to be 175° C. and 190° C.

The PVC composition in Comparative Example 1 is used for manufacturing a sample pipe, the manufacturing method is as described above, and the physical properties of the sample pipe are measured. The results are as shown in Table 1.

### Comparative Example 2

A PVC composition in Comparative Example 2 includes the following components in phr: 100 phr of a PVC resin, 2 phr of an acrylic ester compound (such as PA20), 10 phr of an α-methacrylonitrile copolymer, 1 phr of an MBS toughening agent, 2.5 phr of methyl tin mercaptide, 0.5 phr of epoxidized soybean oil, 0.5 phr of OPE wax, and 0.5 phr of antioxidant I-1010. The components are prepared according to the parts by weight and are put into a high-speed hot mixing machine for dispersing and stirring, in which the stirring temperature is set to be 110° C.; and then the mixed material is discharged into a cold mixing machine for stirring and cooling, and the material is discharged into a hopper after the temperature is lowered to be 40° C., and is extruded, formed and cooled through a double-screw extruder so as to obtain a PVC extruded pipe, in which the temperatures of barrels of the double-screw extruder are respectively set to be 185° C. and 170° C., and the molding temperatures are respectively set to be 175° C. and 190° C.

The PVC composition in Comparative Example 2 is used for manufacturing a sample pipe, the manufacturing method is as described above, and the physical properties of the sample pipe are measured. The results are as shown in Table 1.

In Table 1, the Vicat softening temperature is detected by using a thermal deformation temperature measuring instrument according to the ASTM 1525 specification; the impact strength is detected by using an impact resistance test machine according to ASTM D256 standard; the transparency and the haze are detected by using a haze meter (such as NDK NDH7000); and the plasticizing rate and the processing torque are detected by using a torque rheometer.

TABLE 1

| | | | | | | Com- | Com- |
|---|---|---|---|---|---|---|---|
| | | | | | | parative | parative |
| Item | | Example 1 | Example 2 | Example 3 | Example 4 | Example 1 | Example 2 |
| PVC resin | PVC resin (phr) | 100 | 100 | 100 | 100 | 100 | 100 |
| composition | Chloroethylene | 2 | 2 | 2 | 2 | — | — |
| | and polyester | | | | | | |
| | copolymer (phr) | | | | | | |
| | Grafted | Ethylene/ | Ethylene/ | Vinylidene | Vinylidene | — | — |
| | functional | vinyl | vinyl | chloride/ | chloride/ | | |
| | group | acetate | acetate | vinyl | vinyl | | |
| | | | | versatate | versatate | | |
| | Acrylic ester | 0 | 0 | 0 | 0 | 0 | 2 |
| | compound | | | | | | |
| | (such as PA20) | | | | | | |
| | (phr) | | | | | | |
| | Transparent | 1 | 1 | 1 | 1 | 1 | 1 |
| | toughening | | | | | | |
| | agent(phr) | | | | | | |
| | Material | MBS | MBS | MBS | MBS | MBS | MBS |
| | type of | | | | | | |
| | transparent | | | | | | |
| | toughening | | | | | | |
| | agent | | | | | | |
| | Plasticizer | 0 | 0 | 0 | 0 | 3 | 0 |
| | (phr) | | | | | | |
| | Type of | — | — | — | — | DOTP | — |
| | plasticizer | | | | | | |
| | Heat | 10 | 10 | 10 | 10 | 0 | 10 |
| | resistance | | | | | | |
| | improving | | | | | | |
| | agent (phr) | | | | | | |
| | Material | α methyl | α methyl | α methyl | α methyl | — | α methyl |
| | type of a | styrene | styrene | styrene | styrene | | styrene |
| | heat | acrylo- | acrylo- | acrylo- | acrylo- | | acrylo- |
| | resistance | nitrile | nitrile | nitrile | nitrile | | nitrile |
| | improving | | | | | | |
| | agent | | | | | | |
| | Heat | 2.5 | 2.5 | 2.5 | 2.5 | 2.5 | 2.5 |
| | stabilizer | | | | | | |
| | (phr) | | | | | | |
| | Material | Methyl | Methyl | Methyl | Methyl | Methyl | Methyl |
| | type of | tin | tin | tin | tin | tin | tin |
| | heat | mercap- | mercap- | mercap- | mercap- | mercap- | mercap- |
| | stabilizer | tide | tide | tide | tide | tide | tide |
| | Auxiliary | 0.5 | 0.5 | 0.5 | 0.5 | 0.5 | 0.5 |
| | heat | | | | | | |
| | stabilizer | | | | | | |
| | (phr) | | | | | | |
| | Material | Epoxi- | Epoxi- | Epoxi- | Epoxi- | Epoxi- | Epoxi- |
| | type of | dized | dized | dized | dized | dized | dized |
| | auxiliary | soybean | soybean | soybean | soybean | soybean | soybean |
| | heat | oil | oil | oil | oil | oil | oil |
| | stabilizer | | | | | | |
| | Lubricant | 0.1 | 0.5 | 0.1 | 0.5 | 0.1 | 0.5 |
| | (phr) | | | | | | |
| | Material | OPE | OPE | OPE | OPE | OPE | OPE |
| | type of | wax | wax | wax | wax | wax | wax |
| | lubricant | | | | | | |
| | Antioxidant | 0.5 | 0.5 | 0.5 | 0.5 | 0.5 | 0.5 |
| | (phr) | | | | | | |
| | Material | I-1010 | I-1010 | I-1010 | I-1010 | I-1010 | I-1010 |
| | type of | | | | | | |
| | antioxidant | | | | | | |
| | Pigment(phr) | 0.0005 | 0.0005 | 0.0005 | 0.0005 | 0.0005 | 0.0005 |
| | Material | Ultra- | Ultra- | Ultra- | Ultra- | Ultra- | Ultra- |
| | type of | marine | marine | marine | marine | marine | marine |
| | pigment | | | | | | |
| Physicochemical | Vicat | 81.5 | 81.2 | 81.8 | 81.4 | 65.3 | 80.3 |
| properties | softening | | | | | | |
| | tempera- | | | | | | |
| | ture (° C.) | | | | | | |
| | Impact | 3.5 | 3.4 | 3.8 | 3.7 | 2.8 | 3.0 |
| | strength | | | | | | |
| | (Kgf- | | | | | | |
| | cm/cm²) | | | | | | |
| | Trans- | 85.3 | 68.3 | 85.4 | 69.1 | 78.5 | 63.5 |
| | parency | | | | | | |
| | (%) | | | | | | |
| | Haze | 7.1 | 17.7 | 6.7 | 16.6 | 11.7 | 22.8 |
| | Plasticizing | 21 | 25 | 23 | 29 | 18 | 21 |
| | rate (s) | | | | | | |
| | Balance | 11.3 | 11.1 | 11.5 | 11.3 | 10.8 | 13.2 |
| | torque | | | | | | |
| | (N · m) | | | | | | |
| | Processing | Good | Good | Good | Good | Poor | Fair |
| | formability | | | | | | |

### Results and Discussion

It can be seen from comparison between Examples 1 and 3, and Comparative Examples 1 and 2 that, the addition of the ethylene-vinyl acetate copolymer or vinylidene chloride-vinyl versatate copolymer effectively improves the transparency and toughness of the pipe and reduces the haze of the pipe.

It can be seen from comparison between Examples 1 to 4, and Comparative Examples 1 and 2 that, the addition of the ethylene-vinyl acetate copolymer or vinylidene chloride-vinyl versatate copolymer significantly improves the processing formability, without adding any plasticizer.

It can be seen from comparison between Examples 1 and 3, and Comparative Example 2, Example 2, and Example 4 that, the addition of the high-proportion external lubricant results in significantly reduced transparency and increased haze of the pipe.

It can be seen from comparison between Examples 1 and 3, and Comparative Example 1 that, in the presence of the ethylene-vinyl acetate copolymer or vinylidene chloride-vinyl versatate copolymer, the addition amount of the external lubricant is reduced, resulting in increased transparency and reduced haze of the pipe, and improved processing formability.

It can be seen from comparison between Examples 1 to 4, Comparative Example 2, and Comparative Example 1 that, the addition of the α-methacrylonitrile copolymer effectively increases the Vicat softening temperature of the pipe.

It can be seen from comparison between Examples 1 to 4 and Comparative Example 2, the addition of the ethylene-vinyl acetate copolymer or vinylidene chloride-vinyl versatate copolymer can reduce the processing torque, resulting in reduced load on devices without compromising the plasticizing rate of the resin system. Therefore, the ethylene-vinyl acetate copolymer or vinylidene chloride-vinyl versatate copolymer may be used to replace a traditional gelling-promoting processing aid mainly including an acrylic ester compound.

### Beneficial Effects of the Embodiments

In conclusion, the PVC resin composition of the present disclosure is composed of the abovementioned formula, that is, the PVC resin composition is a combination of a component (A), a component (B) and a component (C) in specific weight proportions, so that the PVC resin composition can achieve the beneficial effects of rapid plasticization at low temperature, reduced addition amounts of an external lubricant and an anti-impact agent, improved heat resistance and transparency (up to 85% or more) of products, and improved processing formability. Therefore, the PVC resin composition can satisfy the performance or process requirements of a transparent pipe (such as a protective pipe and a double-casing pipe), and can be widely applied to industries such as semiconductors, electronics, chemistry, water treatment, and pharmaceuticals. Moreover, the PVC resin composition composed of the abovementioned formula can be used for manufacturing a transparent pipe without adding any plasticizer.

Further, the component (B) modifier (i.e., a polymer of ethylene or a derivative of ethylene, and a polyester) is crucial in the performance of a cured product of the PVC resin composition. The modifier can improve the plasticization rate, and can also produce an anti-impact synergistic effect (the effect of synergistic anti-impact modification) when used in combination with the PVC toughening agent (e.g., an elastomer toughening agent). Accordingly, the addition amount of the anti-impact agent can be reduced, and the modifier can be used to replace a traditional gelling-promoting processing aid mainly including an acrylic ester compound. In addition, the component (B) modifier has a good lubricating effect, so the addition amount of the external lubricant can be reduced.

Further, the component (C) heat resistance improving agent can be an α-methacrylonitrile copolymer that has a higher heat deflection temperature and good compatibility with PVC, and is beneficial to improving the heat resistance, toughness and transparency of products.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A PVC resin composition for manufacturing a pipe having high heat resistance and transparency, comprising:
(A) 100 phr of a PVC resin, wherein a degree of polymerization of the PVC resin is from 800 to 1,350;
(B) 0.5 phr to 5 phr of a modifier, wherein the modifier is a polymer containing a first monomer and a second monomer, the first monomer is ethylene or a derivative of ethylene, and the second monomer is a polyester; and
(C) 1 phr to 10 phr of a heat resistance improving agent.

2. The PVC resin composition according to claim 1, wherein the modifier is a copolymer of the first monomer and the second monomer, the first monomer is ethylene, and the second monomer is vinyl acetate.

3. The PVC resin composition according to claim 1, wherein the modifier is a copolymer of the first monomer and the second monomer, the first monomer is vinylidene chloride, and the second monomer is vinyl versatate.

4. The PVC resin composition according to claim 1, wherein the heat resistance improving agent is an α-methacrylonitrile copolymer.

5. The PVC resin composition according to claim 1, further comprising: (D) at least one functional additive selected from a group consisting of a toughening agent, a heat stabilizer, a lubricant, and an antioxidant.

6. The PVC resin composition according to claim 5, wherein the toughening agent includes at least one of an acrylic resin (ACR) elastomer and a methyl methacrylate-butadiene-styrene resin (MBS resin) elastomer, and an addition amount of the toughening agent is from 1 phr to 10 phr relative to 100 phr of the PVC resin.

7. The PVC resin composition according to claim 5, wherein the heat stabilizer includes at least one of a thiol ester organotin, an epoxy compound, a hydrotalcite compound, and a calcium zinc stabilizer, and an addition amount of the heat stabilizer is from 1 phr to 5 phr relative to 100 phr of the PVC resin.

8. The PVC resin composition according to claim 5, wherein the lubricant includes at least one of polyethylene wax and oxidized polyethlene wax, and an addition amount of the lubricant is from 0.1 phr to 0.5 phr relative to 100 phr of the PVC resin.

9. The PVC resin composition according to claim 5, wherein the antioxidant includes at least one of a hindered phenol antioxidant and a phosphite ester antioxidant, and an addition amount of the antioxidant is from 0.1 phr to 1 phr relative to 100 phr of the PVC resin.

10. The PVC resin composition according to claim 1, wherein the PVC resin includes at least one of a bulk-polymerized PVC resin and a suspension-polymerized PVC resin.

11. A method for manufacturing a pipe having high heat resistance and transparency, comprising:
sequentially performing hot mixing and cold mixing on the PVC resin composition according to claim 1 to obtain a mixed material; and
melting the mixed material and performing extrusion molding on the mixed material.

12. The method according to claim 11, wherein the mixed material is heated to from 100° C. to 120° C. through hot mixing, and then is cooled to from 35° C. to 50° C. through cold mixing.

13. The method according to claim 11, wherein the melting temperature of the mixed material is from 170° C. to 200° C.
